(19) United States
(12) Patent Application Publication
(10) Pub. No.: US 2026/0300702 A1
(43) Pub. Date: Oct. 1, 2026

(54) QUANTIZATION METHOD OF DIFFUSION MODEL AND ELECTRONIC DEVICE

(71) Applicant: SAMSUNG ELECTRONICS CO., LTD., Suwon-si (KR)

(72) Inventors: Kefei Liu, Xi'an (CN); Ji Li, Xi'an (CN); Ke Lu, Xi'an (CN)

(21) Appl. No.: 19/222,809

(22) Filed: May 29, 2025

(30) Foreign Application Priority Data
Apr. 1, 2025 (CN) 202510407217.2

(51) Int. Cl. G06N 3/0495

(52) U.S. Cl. CPC G06N 3/0495

(57) ABSTRACT

A quantization method of a diffusion model comprises performing post-training quantization on a first diffusion model, to obtain a second diffusion model; dividing time steps of the second diffusion model into a plurality of time step groups; adjusting a weight of the second diffusion model for each of the plurality of time step groups, to obtain a third diffusion model; training the third diffusion model using an output of the first diffusion model, to adjust adjustment parameters of the third diffusion model, wherein the adjustment parameters of the third diffusion model reflect a change of a weight of the third diffusion model with respect to a weight of the second diffusion model; and quantizing the adjusted adjustment parameters of the third diffusion model to obtain a quantized diffusion model.

### CROSS-REFERENCE TO RELATED APPLICATIONS

This application claims priority under 35 U.S.C. § 119 to Chinese Patent Application No. 202510407217.2, filed with the China National Intellectual Property Administration on Apr. 1, 2025, the disclosure of which is incorporated by reference herein in its entirety.

### BACKGROUND

Diffusion model has shown excellent performance in many fields that need to generate high-quality samples. However, there is a huge calculation cost in the operation of diffusion model.

Post-training Quantization (PTQ) is a common model quantization algorithm. It is applied after a model training is completed, aiming at reducing a size of the model and improving an inference speed, while maintaining the model performance as much as possible.

However, performance of current PTQ technology in quantification of diffusion model may not meet the expectations. Because the diffusion model needs to perform hundreds of de-noising, and an amount of parameters of the diffusion model is huge, a cumulative error caused by the quantization of the diffusion model will seriously affect the quality of the output data of the diffusion model.

### SUMMARY

In general, the present disclosure is directed toward a quantization method of a diffusion model and an electronic device. By grouping time steps based on a degree of importance thereof and obtaining adjustment parameters for each time step group, the cumulative error of diffusion model caused by multiple de-noising may be reduced. In addition, by further fine-tuning the adjustment parameters for adjacent two time step groups, an over-fitting problem caused by multiple sets of adjustment parameters may be avoided. Therefore, quantization accuracy of the diffusion model may be improved without introducing too much additional calculation and with occupying less memory resources.

According to some implementations, the present disclosure is directed to a quantization method of a diffusion model comprising performing post-training quantization on a first diffusion model, to obtain a second diffusion model; dividing time steps of the second diffusion model into a plurality of time step groups; adjusting a weight of the second diffusion model for each of the plurality of time step groups, to obtain a third diffusion model; training the third diffusion model using an output of the first diffusion model, to adjust adjustment parameters of the third diffusion model, wherein the adjustment parameters of the third diffusion model reflect a change of a weight of the third diffusion model with relative to a weight of the second diffusion model; and quantizing the adjusted adjustment parameters of the third diffusion model to obtain a quantized diffusion model.

According to some implementations, the present disclosure is directed to an electronic device comprising a memory configured to store a first diffusion model to be quantized; a processor configured to: perform post-training quantization on the first diffusion model, to obtain a second diffusion model; divide time steps of the second diffusion model into a plurality of time step groups; adjust a weight of the second diffusion model for each of the plurality of time step groups, to obtain a third diffusion model; train the third diffusion model using an output of the first diffusion model, to adjust adjustment parameters of the third diffusion model, wherein the adjustment parameters of the third diffusion model reflect a change of a weight of the third diffusion model relative to a weight of the second diffusion model; and quantize the adjusted adjustment parameters of the third diffusion model to obtain a quantized diffusion model.

According to some implementations, the present disclosure is directed to a non-transitory computer-readable storage medium storing instructions that, when executed by a processor, cause the processor to execute the above quantization method.

### BRIEF DESCRIPTION OF THE DRAWINGS

Example implementations will be more clearly understood from the following detailed description, taken in conjunction with the accompanying drawings.

FIG. 1 is a diagram illustrating an example of a diffusion model according to some implementations.

FIG. 2 illustrates a diagram of an example of a LoRA algorithm according to some implementations.

FIG. 3 is a block diagram illustrating an example of a quantization method of diffusion model according to some implementations.

FIG. 4 is a block diagram illustrating an example of a method of grouping time steps according to some implementations.

FIGS. 5A and 5B are diagrams illustrating an example of quantization error at each time step of a diffusion model according to some implementations.

FIG. 6 is a diagram illustrating an example of adjusting a weight of a second diffusion model for each time step group according to some implementations.

FIG. 7 is a diagram illustrating an example of training a quantized diffusion model using an output of an original diffusion model according to some implementations.

FIG. 8 is a diagram illustrating an example of a quantization method of diffusion model according to some implementations.

FIG. 9 is a diagram illustrating an example of performing image processing using a quantized diffusion model according to some implementations.

FIG. 10 is a block diagram illustrating an example of an electronic device according to some implementations.

### DETAILED DESCRIPTION

Hereinafter, example implementations will be described in detail with reference to the accompanying drawings. The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed herein are merely intended for the purpose of describing the examples and the examples may be implemented in various forms. The examples are not meant to be limited, but it is intended that various modifications, equivalents, and alternatives are also covered within the scope of the claims.

In the present disclosure, although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

In the present disclosure, it will be understood that when a component is referred to as being “connected to” another component, the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

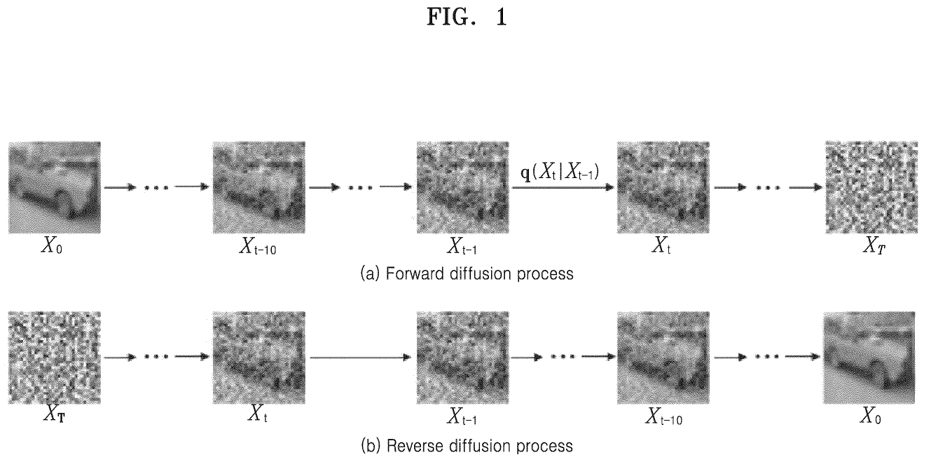

FIG. 1 is a diagram illustrating an example of a diffusion model according to some implementations.

A diffusion model is a generative model that may generate desired data from Gaussian noise, and it is widely used in image processing (for example, image de-noising, image restoration, improvement of image resolution), text processing (for example, Text-to-Image Generation), and/or voice processing (for example, voice enhancement). In some implementations, the diffusion model may be trained using a series of face images as a training set, so that the diffusion model may generate new face images with various features and expressions. In another example embodiment, the diffusion model may be trained using noisy speech as the training set, so that the diffusion model may predict noise, thereby generating clear speech in which noise is removed from fuzzy speech.

The diffusion model obtains knowledge about data distribution through a Markov chain process. The processing of diffusion model usually includes two processes: a forward diffusion process and a reverse diffusion process. The forward diffusion process provides labeled training samples for the training of diffusion model. Taking image processing as an example, in the forward diffusion process, noise is gradually added to a known image until the image becomes standard Gaussian noise completely. In the reverse diffusion process, noise estimation ability of diffusion model is trained using the added noise as labels.

In FIG. 1, in the forward diffusion process, Gaussian noise is added to a sample data x₀~q(x) iteratively according to a specific variable sampler, and T time steps are iterated, and thus a set of noise sample sequences x₁, . . . , x_{T} is obtained.

$$q ( {x}_{t} \vert {x}_{t - 1} ) = N ( {x}_{t} ; \sqrt{1 - {β}_{t}} {x}_{t - 1} , {β}_{t} I ) \qquad ( 1 )$$

In equation (1), q(xₜ|xₜ₋₁) represents the forward diffusion process; N indicates that random noise conforms to a Gaussian distribution; I is an initial value of variance of the Gaussian distribution, which is used to measure an intensity of noise in an initial stage; βₜ is a preset noise parameter, and the subscript t represents a time step.

On the contrary, the reverse diffusion (de-noising) process gradually generates high-quality data (e.g., images) by removing noise from data with noise. Because a real reverse process q(xₜ₋₁|xₜ) is not available, the diffusion model performs sample through a learnable conditional probability distribution.

$${p}_{θ} ( {x}_{t - 1} \vert {x}_{t} ) = N ( {x}_{t - 1} ; {\tilde{μ}}_{θ} ( {x}_{t} , t ) , {\tilde{β}}_{t} I ) \qquad ( 2 )$$

The mean value \tilde{μ}_{θ} may be obtained by a Reparametrization Trick, as shown in the following equation (3).

$${\tilde{μ}}_{θ} ( {x}_{t} , t ) = \frac{1}{\sqrt{{a}_{t}}} ( {x}_{t} - \frac{{β}_{t}}{\sqrt{1 - {\overline{a}}_{t}}} {ϵ}_{θ} ( {x}_{t} , t ) ) \qquad ( 3 )$$

In equation (3),

$${\overline{a}}_{t} = {\prod }_{i = 1}^{t} {a}_{i} ,$$

and aᵢ=1−βᵢ·ϵ_{θ}(⋅) is a noise estimation model, which is usually a UNet model.

In some implementations, the UNet model may restore a clear image from a noisy image by performing multiple de-noising processes. An input of a UNet model may include a noisy image and a current time step, and an output of the UNet model is a noise included in the current image. A MSE (Mean-Square Error) between the noise predicted by the noise estimation model and a real noise added in the forward diffusion process may be used as a loss function to train the noise estimation model.

However, the diffusion model has a huge computational cost in operation. On the one hand, the diffusion model usually needs to perform hundreds of de-noising steps to generate high-quality images, and each de-noising step requires an inference of the noise estimation model. On the other hand, the structure of the noise estimation model, which has many parameters, is complex, resulting a need for large memory resources.

Low-precision quantization is a model acceleration technique that compresses and accelerates a neural network by quantizing floating-point values of weights and/or activation into integer values with a specified bit width. Generally, the low-precision quantization techniques may be divided into post-training quantization (PTQ) and Quantization Aware Training (QAT).

PTQ obtains quantization parameters using a specific optimization objective function and a small-scale calibration data set by applying quantization parameter reconstruction means in units of layers or blocks, without retraining the network (i.e., without updating the weights), thereby reducing the quantization error. Accordingly, PTQ is more effective and practical than QAT which needs long-term training.

Current PTQ research usually focuses on advanced reconstruction strategy of diffusion model. For example, Quantizing Diffusion (also called Q-Diffusion) explores a method of collecting calibration data sets based on time steps. Temporal Feature Maintenance Quantification for Diffusion Models (also known as TFMQ-DM) focuses on independent reconstruction strategy of time feature modules. Post-training Quantization Diffusion (PTQD) eliminates the quantization error by decomposing quantization noise into relevant and irrelevant parts. Accurate Data-free Post-training Quantization Framework of Diffusion Models (also known as ADP-DM) proposes grouped quantization parameters for inference at different time steps. Low-Rank Adaptation (also called LoRA) helps to restore the quantization error by introducing low-rank matrix parameters.

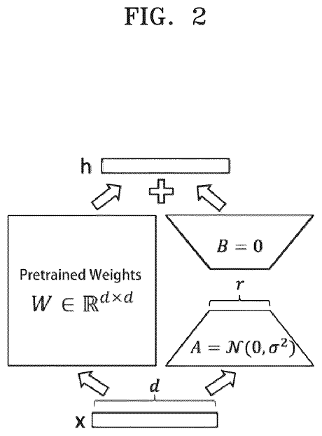

FIG. 2 illustrates a diagram of an example of the LoRA algorithm according to some implementations.

The LoRA algorithm freezes weights of a pre-trained model and injects trainable low-rank decomposition matrices into each weight of the layer (for example, Transformer layer), and significantly reducing a number of trainable parameters of downstream tasks.

In FIG. 2, W is the weight of the pre-training model, with a size of d×d. During the training in which the LoRA algorithm is applied, W is frozen without being updated. Matrix A reduces the input data from d dimension to r dimension, and matrix B changes the data from r dimension to d dimension. During the training, matrix A is initialized with random Gaussian noise, matrix B is zero at the beginning of training, and r is the rank of matrix.

In some implementations, the LoRA algorithm may be expressed by the following equation (4). During the training, the model parameter to be adjusted (i.e. the change of the weight matrix) ΔW may be expressed as a product of two matrices, that is, B and A.

$$h = {W}_{0} x + Δ Wx = {W}_{0} x + BAx \qquad ( 4 )$$

In equation (4), W₀ represents an original weight matrix, A and B are low-rank parameter matrices, x represents an input of the layer, and h represents an output of the layer, where W₀∈ [symbol] , B∈ [symbol] , A∈ [symbol] , and r<<min(d, k).

However, for the low-precision quantitative of diffusion model, the current PTQ algorithm cannot meet the expectations. Because the diffusion model needs hundreds of de-noising steps, and each de-noising step requires an inference of the UNet model, and errors resulting from the quantized UNet model will accumulate continuously, therefore seriously affect the quality of the generated output data.

It's difficult for the current PTQ algorithm to effectively repair the accumulated quantization error while occupying less memory resources. This is because distributions of activation values at different time steps in various layers of the UNet are also quite different. If the same quantization parameters are used at all time steps, the accumulation of quantization errors will be aggravated. If different quantization parameters are applied in inference at different time steps, a lot of memory resources are needed, which will bring a heavy burden to the actual deployment of the diffusion model.

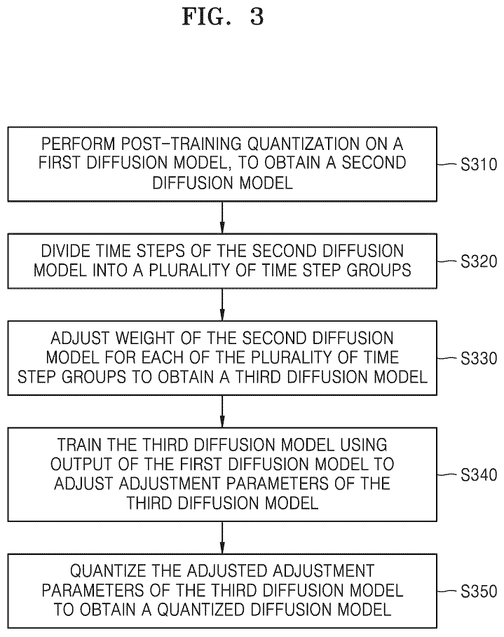

FIG. 3 is a block diagram illustrating an example of a quantization method of diffusion model according to some implementations. In FIG. 3, in operation S310, a post-training quantization may be performed on a first diffusion model to obtain a second diffusion model.

In some implementations, the first diffusion model may be a pre-trained original diffusion model, and may have high accuracy (for example, floating point 32 bits, FP32). Various diffusion models (for example, including but not limited to GLIDE, DALL-E, DALL-E 2, Imagen, Stable Diffusion, etc.) may be used as the first diffusion model. In some implementations, the first diffusion model for image generation task may be trained using a training image set. In some implementations, the first diffusion model for speech enhancement task may be trained using noisy speech data.

For example, the first diffusion model may be a pre-trained Unet model. However, this is only an example, and the present disclosure is not limited thereto. The diffusion model may also be implemented using any other network structure as needed.

The high-precision first diffusion model may be quantized to a second diffusion model based on quantization parameters of the diffusion model obtained according to various PTQ algorithms. The following equations (5) and (6) illustrate the basic principle of the PTQ quantization algorithm.

$$r = S ( q - Z ) \qquad ( 5 )$$

$$q = clip ( round ( \frac{r}{S} + Z ) , {q}_{min} , {q}_{max} ) \qquad ( 6 )$$

In equations (5) and (6), r and q represent a floating point number before quantization and a fixed point number after quantization, respectively, and S and Z are two quantization parameters, where S denotes a scale and Z denotes a zero point. clip denotes a truncation function, and round denotes a rounding function. As shown in the following equations (7) and (8), the quantization parameters S and Z may be calculated based on a range (qₘᵢₙ, qₘₐₓ) of the fixed point number q and the range (rₘᵢₙ, rₘₐₓ) of the floating point number r.

$$S = \frac{{r}_{max} - {r}_{min}}{{q}_{max} - {q}_{min}} \qquad ( 7 )$$

$$Z = clip ( round ( {q}_{max} - \frac{{r}_{max}}{S} ) , {q}_{min} , {q}_{max} ) \qquad ( 8 )$$

Accordingly, when the first diffusion model is a pre-trained high-precision model, the initial quantization parameters S and Z for each layer of the first diffusion model may be obtained using various PTQ algorithms based on the calibration data set, and the first diffusion model may be quantized into the second diffusion model based on S and Z.

It can be seen from equations (6) and (8) that the rounding function round may cause a large quantization error. To this end, further optimization may be performed, after the initial quantization parameters S and Z are obtained, to obtain optimized quantization parameters S′ and Z′.

In some implementations, various reconstruction optimization algorithms may be applied to optimize the rounding function round, so as to fine-tune the initial quantization parameters S and Z of each layer of the first diffusion model, such that the quantization error of the first diffusion model is reduced.

For example, the initial quantization parameters S and Z for weights and activations of each layer of the first diffusion model may be optimized by an adaptive rounding (AdaRound) algorithm, and the first diffusion model may be quantized using the optimized quantization parameters S′ and Z′. However, this is only an example, and the present disclosure is not limited thereto. The initial quantization parameters S and Z may be optimized using any other rounding optimization algorithm.

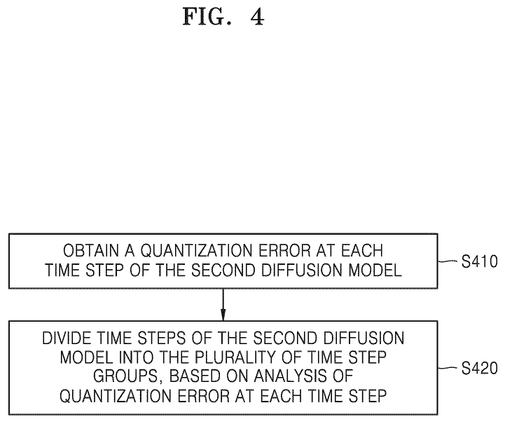

In operation S320, time steps of the second diffusion model may be divided into a plurality of time step groups. Operation S320 will be described in detail with reference to FIG. 4.

FIG. 4 is a block diagram illustrating an example of a method of grouping time steps according to some implementations. In FIG. 4, in operation S410, a quantization error of the second diffusion model at each time step may be obtained.

At each time step, the outputs of the first diffusion model and the second diffusion model for the calibration data set which is an input may be obtained respectively, and the quantization error at each time step of the second diffusion model may be determined based on the outputs of the first diffusion model and the second diffusion model.

In some implementations, the same calibration data set may be input into the high-precision first diffusion model and the quantized second diffusion model respectively, and the first diffusion model and the second diffusion model may be respectively executed at each time step. The outputs of the first diffusion model and the second diffusion model at each time step may be compared. For example, a L2 norm, a cosine similarity, etc. may be used as a measure of the quantization error of the second diffusion model. However, this is only an example, and the present disclosure is not limited thereto. Any other metric may also be used to calculate the quantization error.

In operation S420, analysis on the quantization error at each time step may be performed, so as to divide the time steps of the second diffusion model into the plurality of time step groups.

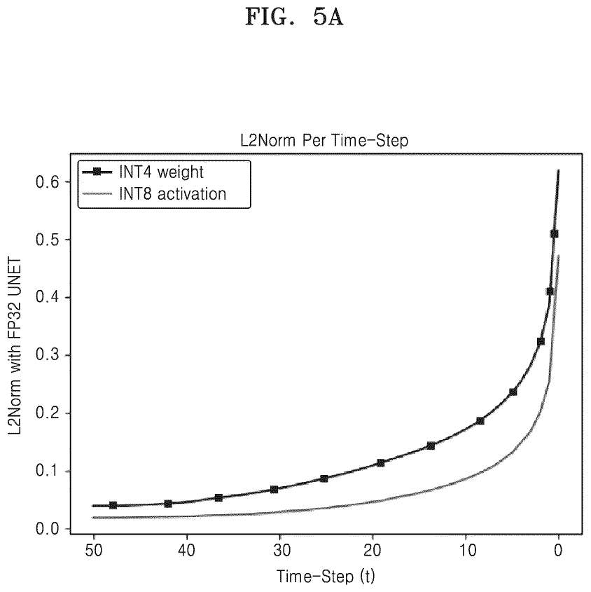

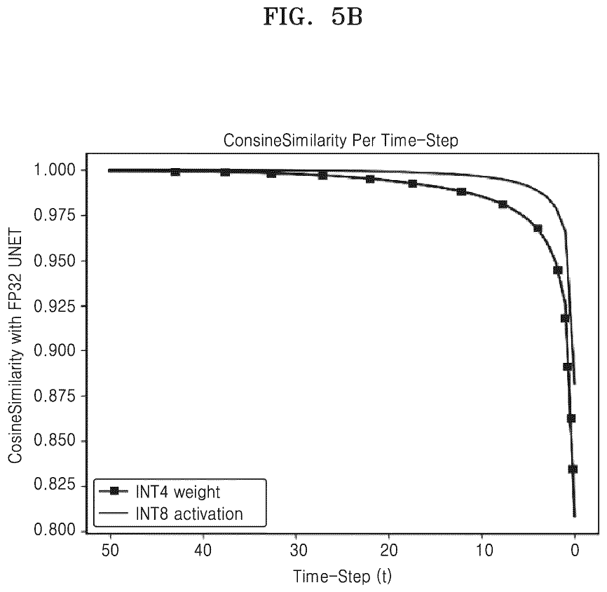

FIGS. 5A and 5B are diagrams illustrating an example of a quantization error at each time step of the diffusion model according to some implementations. In some implementations, referring to FIGS. 5A and 5B, the first diffusion model is the FP32 Unet model, and the weight and activation of the second diffusion model are quantized as INT4 and INT8, respectively. FIG. 5A illustrates the L2 norm between the output of the first diffusion model and the output of the second diffusion model, and FIG. 5B illustrates the cosine similarity between the output of the first diffusion model and the output of the second diffusion model. It can be seen from FIGS. 5A and 5B, as the time step approaches t=0, the quantization error of the second diffusion model increases significantly.

A degree of importance of the time step may be evaluated based on the quantization error. The greater the quantization error, the more the degree of importance of the time step is. The time steps may be grouped based on the degree of importance thereof. In some implementations, continuous time steps with relatively high degree of importance (or with relatively large quantization error) of time step may be divided into more groups, and continuous time steps with relatively low degree of importance (or with relatively small quantization error) of time step may be divided into fewer groups. In another example embodiment, one time step with a relatively large quantization error may constitute a time step group, and a plurality of continuous time steps with a relatively small quantization error may constitute a time step group.

In some implementations, it is assumed that the number of time steps t of the second diffusion model is 50. Based on the analysis of the quantization error at each time step, the time steps of the second diffusion model may be divided into three groups {G₁, G₂, G₃}, where G₁ represents a time step range from t=50 to t=40, G₂ represents a time step range from t=39 to t=11, and G₃ represents a time step range from t=10 to t=0.

By grouping the time steps based on the analysis of quantization errors, the quantization parameters of the second diffusion model may be adjusted in units of time step groups to reduce the accumulation of quantization errors caused by multiple de-noising processes.

In FIG. 3, in operation S330, the weight of the second diffusion model may be adjusted for each of the plurality of time step group, to obtain a third diffusion model.

In some implementations, for each of the time step groups, the second diffusion model may be trained based on the calibration data set across all the time steps included in a time step group, such that the adjustment parameters for each of the time step groups are obtained. The adjustment parameter may reflect a change of the weight of the third diffusion model relative to the weight of the second diffusion model.

In some implementations, the second diffusion model may be trained using the low-rank adaptive LoRA algorithm, and the adjustment parameters may be low-rank parameter matrices A and B of each layer.

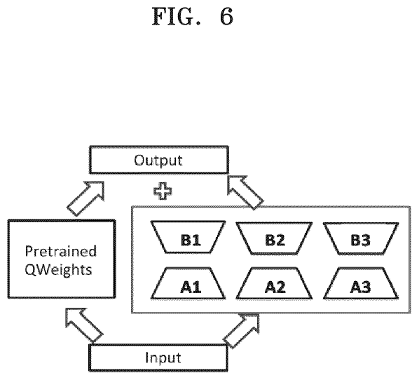

FIG. 6 is a diagram illustrating an example of adjusting the weight of the second diffusion model for each time step group according to some implementations. In FIG. 6, it is assumed that the time steps of the diffusion model have been divided into three time step groups based on the analysis of quantization errors. Different from the method of obtaining the same low-rank parameter matrix (A, B) for all time steps shown in FIG. 2, the quantization method according to an example embodiment of the present disclosure may obtain respective low-rank parameter matrices (A1, B1), (A2, B2) and (A3, B3) for each time step group.

In some implementations, for the time step group G₁, calibration data sets X₅₀ to X₄₀ of each time step included in G₁ may be collected first, and then, from time steps t=50 to t=40, the second diffusion model is executed for each time step using the LoRA algorithm, and the second diffusion model is trained using the mean square error MSE as a loss function to obtain the low-rank parameter matrices (A1, B1) for the time step group G₁.

Next, the above process is repeated for each of the time step groups G₂ and G₃ to obtain the low-rank parameter matrices (A2, B2) and (A3, B3), respectively.

By introducing multiple groups of low-rank parameter matrices based on time step groups, the quantization error of the diffusion model may be reduced. Because LoRA algorithm introduces relatively small low-rank matrix parameters, even if a lot of groups of low-rank parameter matrices are introduced, the increase of computation and the occupation of memory resources are not significant.

In order to avoid an over-fitting problem during the inference of diffusion model due to multiple groups of low-rank parameter matrices, the quantized third diffusion model may further be trained using the high-precision first diffusion model as a teacher model. A flow of de-noising ability of diffusion model between different time steps may be defined as a kind of high-order distillable knowledge. By learning this knowledge of high-precision model to optimize the low-rank parameter matrix of quantized model in the reconstruction process, the over-fitting problem may be avoid effectively using the calibration data sets of different time steps, and the efficiency of reconstruction process is improved.

In FIG. 3, in operation S340, the third diffusion model may be trained using the output of the first diffusion model to adjust adjustment parameters of the third diffusion model. In operation S350, the adjusted adjustment parameters of the third diffusion model may be quantized (for example, quantized into integer) to obtain the quantized diffusion model. In some implementations, the adjusted adjustment parameters may be quantized into 4 bits.

In some implementations, the knowledge of de-noising ability flow may be expressed as output feature maps at two time steps which belong to two time step groups respectively, of the diffusion model. In some implementations, the flow of de-noising ability of the diffusion model may be represented by a flow of time step (FTS) matrix, and the third diffusion model may be trained using the FTS matrix of the high-precision first diffusion model as the learning target, so as to fine-tune the low-rank parameter matrices of two time step groups of the third diffusion model simultaneously, thus avoiding over-fitting. However, this is only an example, and the knowledge of de-noising ability flow may also be expressed using any other function based on the output feature maps at two time steps, belonging to two time step groups respectively, of the diffusion model.

The third diffusion model may be trained using a difference between output feature maps at two time steps of the first diffusion model and output feature maps at the two time steps of the third diffusion model as a loss function, across all adjacent two time step groups, wherein the two time steps belong to the adjacent two time step groups respectively.

The FTS matrix may be calculated based on an inner product of two output feature maps at two time steps of the diffusion model, and the loss function may be constructed based on the difference between the FTS matrix of the first diffusion model and the FTS matrix of the third diffusion model.

In some implementations, the FTS matrix of the diffusion model may be calculated based on the following equation (9).

$${T}_{i}^{ts 1 , ts 2} = {\sum }_{s = 1}^{h} {\sum }_{t = 1}^{w} \frac{{F}_{s , t , i}^{ts 1} \times {F}_{s , t , i}^{ts 2}}{h \times w} \qquad ( 9 )$$

In equation (9), ts1 and ts2 are the two time steps belonging to the adjacent two time step groups respectively, i is an index of layers of the corresponding diffusion model,

$${F}_{s , t , i}^{ts 1}$$

is the output feature map at the time step ts1 of the i-th layer of the corresponding diffusion model,

$${F}_{s , t , i}^{ts 2}$$

is the output feature map at the time step ts2 of the i-th layer of the corresponding diffusion model, h is a height of the output feature map, and w is a width of the output feature map.

After calculating the FTS matrix of the first diffusion model and the FTS matrix of the third diffusion model respectively, the loss function may be constructed based on the difference between the two FTS matrices, so that the adjustment parameters (e.g., low-rank parameter matrices) of the adjacent two time step groups may be fine-tuned simultaneously.

In some implementations, the loss function L_{FTS}(ts1, ts2) for training the third diffusion model may be calculated based on the L2 norm according to the following equation (10). However, this is only an example of calculating the loss function, and the present disclosure is not limited thereto. Any other function form may also be used to construct the loss function.

$${L}_{FTS} ( ts 1 , ts 2 ) = \frac{1}{N} {\sum }_{x} {‖ {T}_{{ϵ}_{θ}}^{ts 1 , ts 2} - {T}_{\text{?}}^{ts 1 , ts 2} ‖}_{2}^{2} \qquad ( 10 )$$

In equation (10), ts1 and ts2 are the two time steps belonging to the adjacent two time step groups respectively, L_{FTS}(ts1, ts2) represents the loss function for the time steps ts1 and ts2, N represents a total number of the calibration data sets X,

$${T}_{{ϵ}_{θ}}^{ts 1 , ts 2}$$

represents a time step flow FTS matrix of the first diffusion model, and

$${T}_{\text{?}}^{ts 1 , ts 2}$$

represents a time step flow FTS matrix of the third diffusion model.

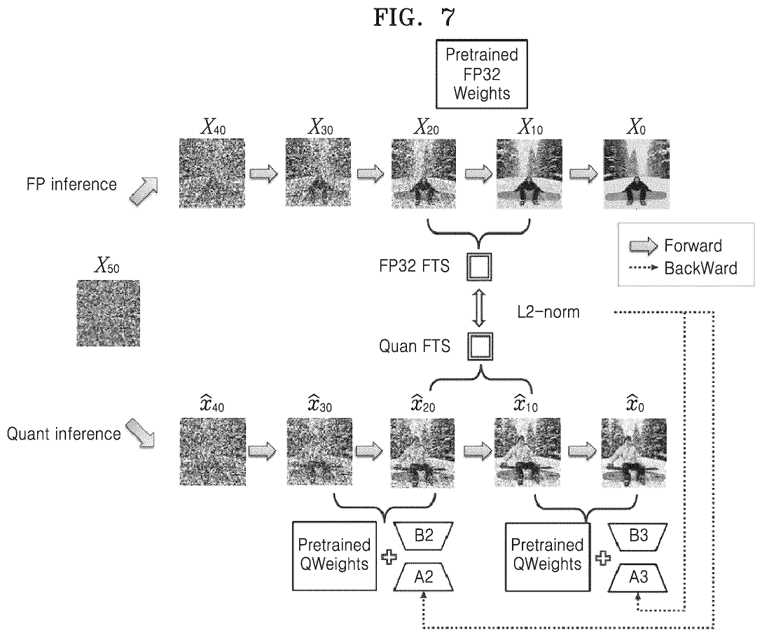

FIG. 7 is a diagram illustrating an example of training a quantized diffusion model using an output of an original diffusion model according to some implementations.

When the weights of the second diffusion model are adjusted for three time step groups in step S330, three sets of low-rank parameter matrices (A1, B1), (A2, B2) and (A3, B3) may be obtained.

Then, in step S340, the low-rank parameter matrices (A1, B1) and (A2, B2) may be fine-tuned simultaneously for time step groups G₁ and G₂, and then the low-rank parameter matrices (A2, B2) and (A3, B3) may be fine-tuned simultaneously for time step groups G₂ and G₃.

FIG. 7 illustrates an example of fine-tuning low-rank parameter matrices (A2, B2) and (A3, B3) for time step groups G₂ and G₃ simultaneously according to some implementations. In FIG. 7, the original diffusion model may be a pre-trained high-precision quantization model (e.g., the first diffusion model), and the third diffusion model may be a diffusion model in which a plurality of sets of low-rank parameter matrices are obtained by applying the LoRA algorithm respectively for time step groups. In FIG. 7, X₅₀ to X₀ respectively represent data sets input to the first diffusion model from time step t=50 to time step t=0, and X₅₀ to \hat{x}₀ respectively represent data sets input to the third diffusion model from time step t=50 to time step t=0.

In FIG. 7, the time step t=20 in time step group G₂ and the time step t=10 in time step group G₃ may be selected, and the FTS matrices of the first diffusion model and the third diffusion model at the two time steps (in FIG. 7, respectively expressed as FP32 FTS and Quan FTS) may be calculated, and a backward propagation is performed using the L2 norm (L2-norm) between FTS matrices, such that the low-rank parameter matrices (A2, B2) and (A3, B3) are updated.

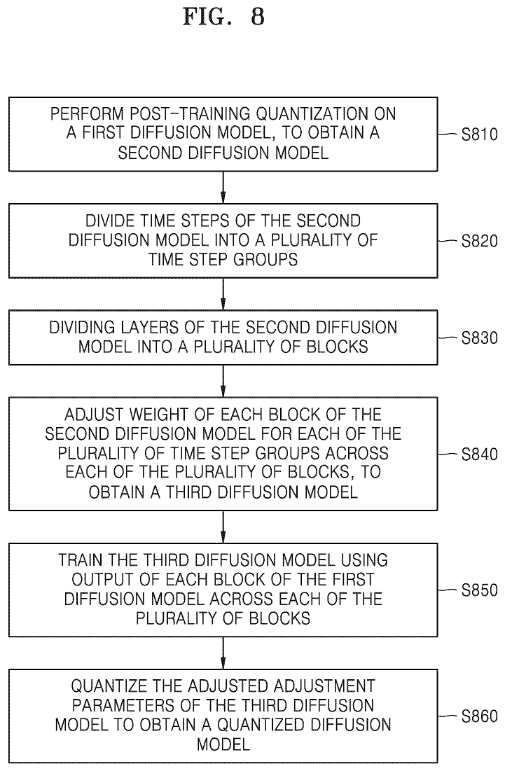

FIG. 8 is a diagram illustrating an example of a quantization method of diffusion model according to some implementations.

In some implementations, a structure analysis of the diffusion model may also be performed, the layers of the diffusion model may be divided into a plurality of blocks, the adjustment parameters for each time step group may be calculated in units of block, and the adjustment parameters may be further adjusted in units of block.

In FIG. 8, steps S810 and S820 may be the same as steps S310 and S320 described with reference to FIG. 3, and detailed description thereof will be omitted for brevity.

In step S830, layers of the second diffusion model may be divided into a plurality of blocks. For example, the layers of the second diffusion model may be divided into a residual block and an attention block. In another example, each of layers of the diffusion model may be used as a separate block. However, this is only an example, and the present disclosure is not limited thereto.

In step S840, for each of the plurality of time step groups, a weight of each of blocks of the second diffusion model may be trained across each of the plurality of blocks, to obtain a third diffusion model. In some implementations, for a first block of the diffusion model, the LoRA algorithm may be applied for each time step group to obtain adjustment parameters (for example, a low-rank parameter matrix).

In step S850, the third diffusion model may be trained using the output of each block of the first diffusion model across each of the plurality of blocks. In some implementations, after the adjustment parameters of the first block of the diffusion model for each time step group are obtained, the FTS-based loss function may be used to fine-tune the low-rank parameter matrix for every adjacent two time step groups.

The above steps may be repeated for each remaining block to obtain the adjustment parameters of all blocks.

In step S860, the adjusted adjustment parameters of the third diffusion model may be quantized to obtain a quantized diffusion model.

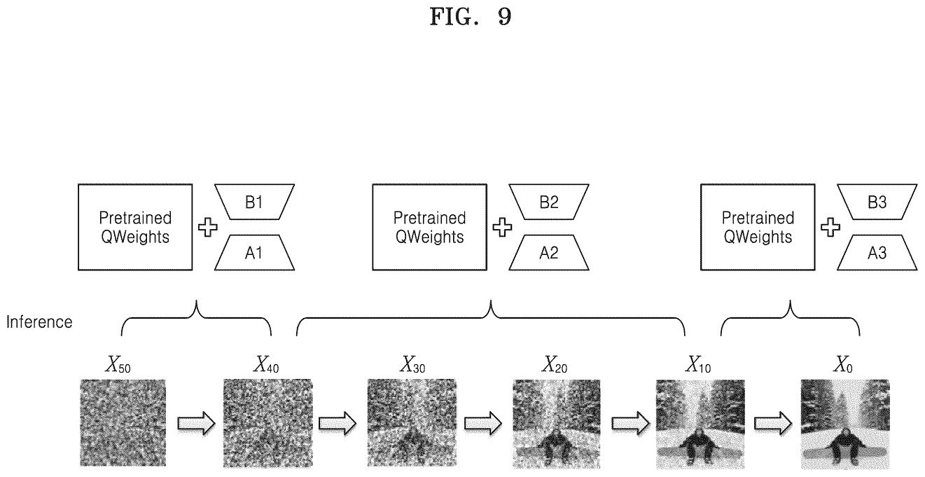

FIG. 9 is a diagram illustrating performing an example of image processing using a quantized diffusion model according to some implementations. In FIG. 9, at time steps t=50 to t=40, an inference may be performed based on a first set of low-rank parameter matrices (A1, B1), at time steps t=39 to t=11, the inference may be performed based on a second set of low-rank parameter matrices (A2, B2), and at time steps t=10 to t-0, the inference may be performed based on a third set of low-rank parameter matrices (A3, B3).

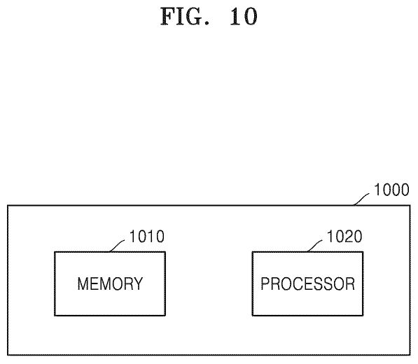

FIG. 10 is a block diagram illustrating an example of n electronic device according to some implementations.

The quantization method may be deployed on various electronic devices through software or hardware. Electronic devices may include, for example, desktop computers, laptop computers, tablet computers, smart phones, wearable electronic devices (e.g., smart bracelets, smart watches, etc.), virtual reality devices, and the like. However, the present disclosure is not limited thereto, and the electronic device according to the present disclosure may be any electronic device having a function of processing multimedia data (for example, at least one of image data, text data and voice data).

The quantization method may also be deployed on a server. The server may be located in the cloud or locally, and it may be a physical device or a virtual device, such as a virtual machine, a container and the like. For example, the server may be located in the cloud and communicate with a terminal equipment. The server receives the original diffusion model transmitted by the terminal equipment, quantizes the original diffusion model using the quantization method deployed in the server, and returns the quantized target diffusion model to the terminal equipment.

In FIG. 10, the electronic device 1000 may include a memory 1010 and a processor 1020. The memory 1010 may store the original diffusion model (i.e., the first diffusion model) to be quantized. The original diffusion model may be a pre-trained high-precision model.

The processor 1020 may quantize the first diffusion model based on a quantization method. Specifically, the processor 1020 may perform post-training quantization on a first diffusion model, and obtain a second diffusion model. The processor 1020 may divide time steps of the second diffusion model into a plurality of time step groups, and adjust a weight of the second diffusion model of the plurality of time step groups to obtain a third diffusion model. Next, the processor 1020 may train the third diffusion model using an output of the first diffusion model, to adjust adjustment parameters of the third diffusion model. Finally, the processor 1020 may quantize the adjusted adjustment parameters of the third diffusion model to obtain a final quantized diffusion model.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In an example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in the present disclosure are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods, as described above, are written as computer programs, code segments, instructions or any combination thereof, for individually or collectively instructing or configuring the processor or computer to operate as a machine or special-purpose computer to perform the operations performed by the hardware components and the methods as described above. In an example, the instructions and/or software include machine code that is directly executed by the processor or computer, such as machine code produced by a compiler. In another example, the instructions or software include higher-level code that is executed by the processor or computer using an interpreter. Persons and/or programmers of normal skill in the art may readily write the instructions and/or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include at least one of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A quantization method of a diffusion model comprising:
obtaining a second diffusion model by performing post-training quantization on a first diffusion model;
dividing time steps of the second diffusion model into a plurality of time step groups;
obtaining a third diffusion model by adjusting a weight of the second diffusion model for each time step group of the plurality of time step groups;
adjusting adjustment parameters of the third diffusion model by training the third diffusion model using an output of the first diffusion model, wherein the adjustment parameters of the third diffusion model reflect a change of a weight of the third diffusion model relative to a weight of the second diffusion model; and
obtaining a quantized diffusion model by quantizing the adjusted adjustment parameters of the third diffusion model.

2. The quantization method of claim 1, wherein the first diffusion model comprises a pre-trained Unet model.

3. The quantization method of claim 1, wherein the dividing of time steps of the second diffusion model into the plurality of time step groups comprises:
obtaining a quantization error at the time steps of the second diffusion model;
dividing, based on analysis of the quantization error at the time steps, the time steps of the second diffusion model into the plurality of time step groups.

4. The quantization method of claim 3, wherein the obtaining of the quantization error at the time steps of the second diffusion model comprises:
at each time step of the second diffusion model, obtaining output of the first diffusion model and the second diffusion model for a calibration data set respectively input to the first diffusion model and the second diffusion model; and
determining the quantization error, at each time step of the second diffusion model, based on output of the first diffusion model and the second diffusion model.

5. The quantization method of claim 4, wherein the dividing of time steps of the second diffusion model into the plurality of time step groups comprises:
evaluating a degree of importance of the time steps based on the quantization error; and
grouping the time steps based on the degree of importance of the time steps.

6. The quantization method of claim 1, wherein the adjusting a weight of the second diffusion model comprises:
for each time step group of the plurality of time step groups, training the second diffusion model based on a calibration data set for the time steps included in the corresponding time step group; and
obtaining the adjustment parameters for each time step group of the plurality of time step groups.

7. The quantization method of claim 6, wherein the second diffusion model is trained using a low-rank adaptive LoRA algorithm.

8. The quantization method of claim 7, wherein the adjustment parameters comprise a low-rank parameter matrix of each layer of the second diffusion model.

9. The quantization method of claim 1, wherein the training of the third diffusion model using the output of the first diffusion model comprises:
training the third diffusion model using a difference between output feature maps at two time steps of the first diffusion model and output feature maps at the two time steps of the third diffusion model as a loss function across adjacent two time step groups,
wherein the two time steps belong to the adjacent two time step groups respectively.

10. The quantization method of claim 9, wherein the loss function is calculated based on the following equation:
$${L}_{FTS} ( ts 1 , ts 2 ) = \frac{1}{N} {\sum }_{x} {‖ {T}_{{ϵ}_{θ}}^{ts 1 , ts 2} - {T}_{\text{?}}^{ts 1 , ts 2} ‖}_{2}^{2}$$
wherein ts1 and ts2 are the two time steps belonging to the adjacent two time step groups, L_{FTS}(ts1, ts2) represents the loss function for the time steps ts1 and ts2, N represents a total number of calibration data sets x,
$${T}_{{ϵ}_{θ}}^{ts 1 , ts 2}$$
represents a time step flow (FTS) matrix of the first diffusion model, and
$${T}_{\text{?}}^{ts 1 , ts 2}$$
represents a FTS matrix of the third diffusion model, and
wherein the FTS matrix of the first diffusion model and the FTS matrix of the third diffusion model are calculated based on an inner product of the output feature maps at the two time steps of the corresponding diffusion model.

11. The quantization method of claim 10, wherein the FTS matrix is calculated based on the following equation:
$${T}_{i}^{ts 1 , ts 2} = {\sum }_{s = 1}^{h} {\sum }_{t = 1}^{w} \frac{{F}_{s , t , i}^{ts 1} \times {F}_{s , t , i}^{ts 2}}{h \times w}$$
wherein i is an index of layers of the corresponding diffusion model,
$${F}_{s , t , i}^{ts 1}$$
is the output feature map at the time step ts1 of the i-th layer of the corresponding diffusion model,
$${F}_{s , t , i}^{ts 2}$$
is the output feature map at the time step ts2 of the i-th layer of the corresponding diffusion model, h is a height of the output feature map, and w is a width of the output feature map.

12. The quantization method of claim 1, further comprising:
dividing layers of the second diffusion model into a plurality of blocks,
wherein the adjusting the weight of the second diffusion model comprises adjusting the weight of each block of the second diffusion model for each of the plurality of time step groups across each of the plurality of blocks to obtain the third diffusion model, and
wherein the training the third diffusion model using the output of the first diffusion model comprises training the third diffusion model using the output of each block of the first diffusion model across each of the plurality of blocks.

13. The quantization method of claim 12, wherein the dividing layers of the second diffusion model into the plurality of blocks comprises:
dividing the layers of the second diffusion model into a residual block and an attention block.

14. The quantization method of claim 1, wherein the diffusion model is configured to process at least one of image data, text data, and voice data.

15. An electronic device comprising:
a memory configured to store a first diffusion model to be quantized;
a processor configured to:
perform post-training quantization on the first diffusion model and obtain a second diffusion model;
divide time steps of the second diffusion model into a plurality of time step groups;
adjust a weight of the second diffusion model for each of the plurality of time step groups and obtain a third diffusion model;
train the third diffusion model using an output of the first diffusion model and adjust adjustment parameters of the third diffusion model, wherein the adjustment parameters of the third diffusion model reflect a change of a weight of the third diffusion model relative to a weight of the second diffusion model; and
quantize the adjusted adjustment parameters of the third diffusion model and obtain a quantized diffusion model.

16. The electronic device of claim 14, wherein the processor is configured to:
obtain a quantization error at the time steps of the second diffusion model;
divide, based on an analysis of the quantization error at the time steps, the time steps of the second diffusion model into the plurality of time step groups.

17. The electronic device of claim 16, wherein the processor is configured to:
evaluate a degree of importance of the time steps based on the quantization error; and
group the time steps based on the degree of importance of the time steps.

18. The electronic device of claim 14, wherein the processor is configured to:
for each time step group of the plurality of time step groups, train the second diffusion model based on a calibration data set for the time steps included in the time step group; and
obtain the adjustment parameters for each time step group of the plurality of time step groups.

19. The electronic device of claim 14, wherein the processor is configured to:
train the third diffusion model using a difference between output feature maps at two time steps of the first diffusion model and output feature maps at the two time steps of the third diffusion model as a loss function across adjacent two time step groups,
wherein the two time steps belong to the adjacent two time step groups respectively.

20. A non-transitory computer-readable storage medium storing instructions that, when executed by a processor, cause the processor to execute the quantization method of claim 1.
